(19) United States
(12) Patent Application Publication
(10) Pub. No.: US 2011/0280415 A1
(43) Pub. Date: Nov. 17, 2011

(54) SOUND REPRODUCTION AND DETECTION

(75) Inventors: Temujin Gautama, Boutersem (BE); Lise Daubigny, Ottignies (BE); Bram Hedebouw, Heverlee (BE)

(73) Assignee: NXP B.V., Eindhoven (NL)

(21) Appl. No.: 13/104,895

(22) Filed: May 10, 2011

(30) Foreign Application Priority Data
May 11, 2010 (EP) 10162577.0

(51) Int. Cl. H04B 15/00

(52) U.S. Cl. 381/94.2

(57) ABSTRACT

Apparatus for generating a first acoustic signal and simultaneously sensing a second acoustic signal. The apparatus comprises: an input (15) for receiving a first electrical signal from a signal source; a loudspeaker terminal, directly or indirectly connected to the input (15), for connection to a loudspeaker (30) for generating the first acoustic signal in response to the first electrical signal and for generating a second electrical signal in response to the second acoustic signal; and an output (35), for outputting the second electrical signal. The loudspeaker terminal is connected to the output (35) via isolation means (25) comprising a first filter which is adapted to suppress a signal component related to the first electrical signal while simultaneously passing the second electrical signal to the output (35).

This invention relates to sound reproduction and detection using a common transducer, such as a loudspeaker.

Both a loudspeaker and a microphone are transducers capable of converting between electrical energy and acoustic energy. In general, this conversion can occur in either direction. In a loudspeaker, the conversion is intended to be from an electrical driving signal input to the loudspeaker into output acoustic energy (sounds). In a microphone the reverse is intended—incident acoustic waves cause movement of part of the microphone, which induces an electrical signal.

It is known that a loudspeaker can be used as a microphone. US 2007/0019571 describes an apparatus for the use of a single loudspeaker for half-duplex voice communications. Thus, the same loudspeaker is used alternately to reproduce (that is, generate) sound or to register (that is, detect or sense) sound. However, only one of the two functions can be performed in any time interval.

According to US 2006/0211499, an incident audible signal can be sensed while a loudspeaker is being operated to generate sound. The incident signal is detected by subtracting the input signal (which is generating sound) from the output signal at the loudspeaker.

According to a first aspect of the invention there is provided an apparatus for generating a first acoustic signal and simultaneously sensing a second acoustic signal, comprising: an input for receiving a first electrical signal from a signal source; a loudspeaker terminal, directly or indirectly connected to the input, for connection to a loudspeaker for generating the first acoustic signal in response to the first electrical signal and for generating a second electrical signal in response to the second acoustic signal; and an output, for outputting the second electrical signal, wherein the loudspeaker terminal is connected to the output via isolation means comprising a first filter which is adapted to suppress a signal component related to the first electrical signal while simultaneously passing the second electrical signal to the output.

The loudspeaker may be of a conventional type.

The first electrical signal will typically comprise an audio signal—that is, an electrical signal comprising energy in a frequency band which, when converted to an acoustic signal, is audible to humans—such as an electrical signal representing music or a voice.

An “acoustic signal” can include both a sound wave that is transmitted through the air (or any other fluid), and a vibration or mechanical signal that is transmitted through a solid. In other words, the acoustic energy can be transmitted to or from the loudspeaker through any type of medium. Accordingly, the second acoustic signal is any incident signal that can mechanically impart (relative) motion to the voice-coil of the loudspeaker.

The inventors have recognised that, provided there is some way to distinguish the detected second electrical signal from the first electrical signal that is driving the loudspeaker, it is possible—and highly advantageous in some applications—to use a loudspeaker both to sense sound and to generate sound, concurrently.

In the case that the second acoustic signal to be sensed comprises frequency components in a band that does not overlap with the first (input) signal driving the loudspeaker, the frequency components related to the input signal can be suppressed at the output by filtering. This is one simple yet effective way to distinguish or separate the first and second signals.

The first filter may have a first pass-band, and the apparatus may further comprise a second filter connected between the input and the loudspeaker terminal, for suppressing a frequency component of the first electrical signal corresponding to the pass-band of the first filter.

In this arrangement, the first filter and second filter complement one another: the first filter attenuates frequency components that would be passed by the second filter, and vice versa. The second filter limits the input signal to a particular frequency band; at the same time, the first filter filters the combined signal at the loudspeaker terminal, and passes the second signal (in a complementary frequency band) to the output.

The first filter optionally comprises a low-pass filter, for suppressing a high-frequency signal component of the first electrical signal.

In this case, the second signal (the signal to be sensed) should include components at low-frequencies, in the pass-band of the low-pass filter.

Optionally, the second filter comprises a high-pass filter, for suppressing a low-frequency component of the first electrical signal.

If the first (input) signal includes low frequency components—that is, frequencies in the pass-band of the low-pass isolation filter, then these should be removed from the signal before it is used to drive the loudspeaker. Otherwise, they would leak through the isolation filter, to the output. The combination of a low-pass filter at the output and a high-pass filter at the input mean that the first (input) signal and second (sensed) signal are confined to different frequency bands.

The low-pass filter can have a first cut-off frequency and the high-pass filter can have a second cut-off frequency, wherein the first cut-off frequency is preferably less than or equal to the second.

This makes the filter pass-bands substantially distinct, such that there is little or no overlap in the spectra of the two signals. Here, “high-pass” may refer to frequencies in the range audible to humans—nominally 20 Hz to 20 KHz. “Low-pass” then refers to frequencies below this range, sometimes referred to as infrasound. For example, the cut-off frequency of the low-pass filter may be 10 Hz and the cut-off frequency of the high-pass filter may be 30 Hz.

The second acoustic signal to be sensed may comprise a sharp transient signal.

A sharp amplitude peak or transient is broad-band in the frequency domain, in that it contains energy across the spectrum. This is beneficial for sensing, because it means that sharp transient signals can be detected in any desired frequency band. For example, detection can be performed in a band where the input electrical signal contains little or no energy, or at least a band which can safely be removed from the input signal by filtering. In either case, the input signal will not overlap with the signal to be detected, in the detection band. Therefore, the first (input) electrical signal will not interfere with the sensing of the second signal. Sharp amplitude transients can be generated by distinct auditory cues, such as those associated with a mechanical shock or impulse applied to the loudspeaker.

The second acoustic signal may be generated by footsteps of a user carrying the loudspeaker; and the output may be coupled to a pedometer for detecting the footsteps.

This is one advantageous application of the ability to simultaneously generate and detect sound or vibration. The loudspeaker may comprise a headphone worn by the user.

The signal source may be a personal electronic device; the second acoustic signal may be generated by a user tapping the loudspeaker; and the output may be connected to a controller adapted to control the device in response to the tapping.

This is another advantageous application. The loudspeaker may comprise a headphone worn by the user. More preferably, the loudspeaker comprises stereo headphones. This enables different commands to be issued by the user by tapping the left and right headphones.

According to a further aspect of the invention, there is provided a personal audio device, comprising: a loudspeaker; and the apparatus of any preceding claim.

The loudspeaker is preferably a headphone, more preferably stereo headphones.

According to another aspect of the invention, there is provided a method of generating a first acoustic signal and simultaneously sensing a second acoustic signal, comprising: driving a loudspeaker with a first electrical signal to generate the first acoustic signal, wherein the loudspeaker simultaneously generates a second electrical signal in response to the second acoustic signal; and sensing the second electrical signal generated by the loudspeaker, wherein the step of sensing the second electrical signal comprises: receiving a combined electrical signal from the loudspeaker, the combined electrical signal comprising the first electrical signal and the second electrical signal; and filtering the combined electrical signal to suppress the first electrical signal.

The method may further comprise filtering the first electrical signal before it is used to drive the loudspeaker, wherein the filtering applied to the first electrical signal is complementary to the filtering applied to the combined electrical signal.

Here “complementary” means that each filtering operation is designed to suppress frequency components passed by the other filtering operation. For example, if one filtering operation is high-pass, the other would be low-pass.

Also provided is a computer program, comprising computer program code means adapted to perform all the steps of the method when said program is run on a computer; and such a computer program embodied on a computer readable medium.

The invention will now be described by way of example with reference to the accompanying drawings, in which:

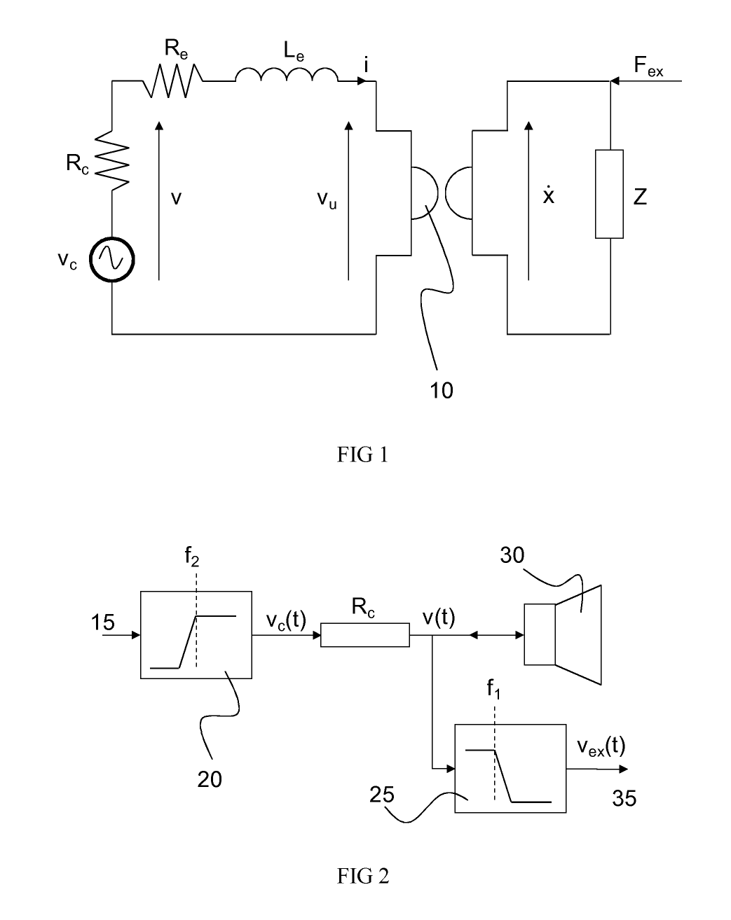

FIG. 1 is a schematic equivalent circuit for a loudspeaker arrangement;

FIG. 2 is a block diagram of a circuit according to an embodiment of the invention;

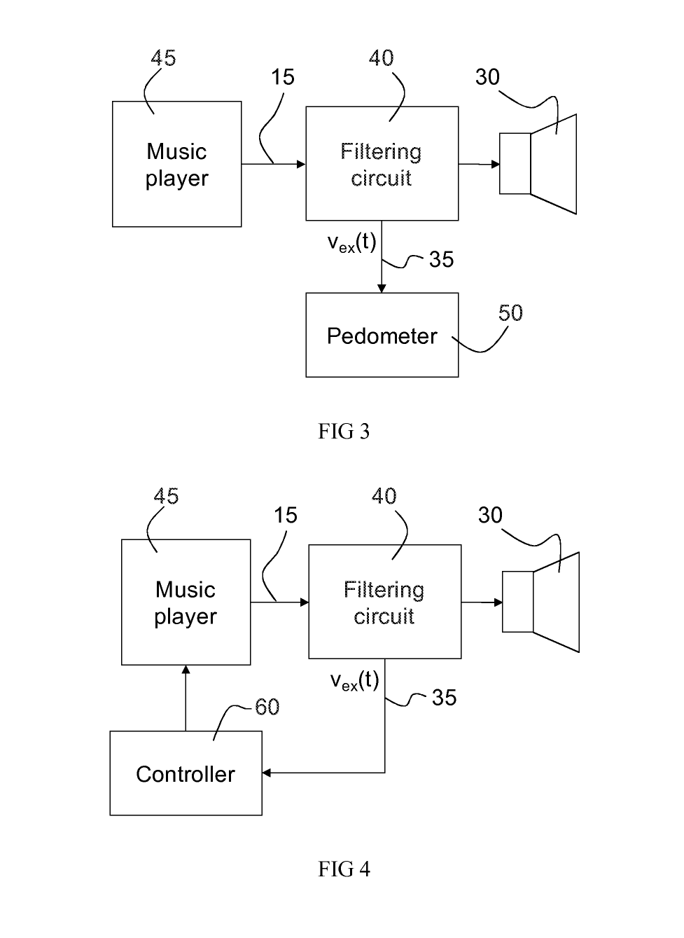

FIG. 3 is an exemplary application of the circuit of FIG. 2; and

FIG. 4 is another exemplary application of the circuit.

The behaviour of a loudspeaker will now described with reference to

FIG. 1. The voltage, v(t), across the voice coil of a loudspeaker can be described by the following equation:

$$v ( t ) = {R}_{e} i ( t ) + {L}_{e} \frac{d i ( t )}{d t} + φ ( x ( t ) ) \dot{x} ( t )$$

where Rₑ and Lₑ are the electrical resistance and inductance, respectively, of the voice coil; i(t) is the current flowing through the voice coil, \dot{x}(t) is the first derivative of the cone-position, x(t), in the loudspeaker; and φ(x(t)) is the force factor function. The voice coil of a loudspeaker is positioned in a magnetic field that is maintained by a fixed, permanent magnet in the magnetic gap of the loudspeaker. The current, i(t), which flows through the voice coil, generates the Lorentz force, F_{L}=φ(x(t)) i(t), that is exerted on the moving part of the loudspeaker. For now, the exogenous force Fₑₓ in FIG. 1 is assumed to be zero.

This interaction is represented by the gyrator in FIG. 1. The Lorentz force, F_{L}, changes the loudspeaker cone velocity, i(t), and cone position, x(t). The exact effect of the Lorentz force on the cone position depends on the mechanical and acoustical properties of the loudspeaker, which are schematically represented by the impedance Z in FIG. 1.

Traditionally, the cone position, x(t), was assumed to be determined solely by the displacement caused by the Lorentz force. According to embodiments of the proposed invention, the cone position, x(t), is determined by a combination of the displacement caused by the Lorentz force, and the displacement caused by an exogenous force exerted on the moving part of the loudspeaker, Fₑₓ(t). To emphasise this, the dependency on the exogenous force is made explicit in the notation: x(Fₑₓ, t). The exogenous force is the result of acoustic energy arriving at the loudspeaker. This acoustic energy may comprise a sound transmitted through the air, or a vibration transmitted through a solid material to the loudspeaker. It may originate from movement of the loudspeaker as a whole—for example, when the loudspeaker is part of a headset (that is, a headphone) that is worn by a user who is jogging, or when the loudspeaker vibrates when the user taps his or her finger against it.

The current, i(t), flowing through the voice coil is also influenced by the exogenous force, since:

φ(x(Fₑₓ,t))i(Fₑₓ,t)=F_{L}(t)+Fₑₓ(t)

Again, to stress this fact, the additional dependency of the current i on Fₑₓ(t) has been included in the notation: i(Fₑₓ; t). The voltage across the voice coil can now be written as:

$$v ( t ) = {R}_{e} i ( {F}_{ex} , t ) + {L}_{e} \frac{d i ( {F}_{ex} , t )}{d t} + φ ( x ( {F}_{ex} , t ) ) \dot{x} ( {F}_{ex} , t )$$

This expression is influenced by the exogenous force, Fₑₓ(t), via \dot{x}(Fₑₓ,t), φ(x(Fₑₓ,t)), and i(Fₑₓ,t). Therefore, the voltage, v(t), across the voice coil has a component that is related to the exogenous force, Fₑₓ(t).

The loudspeaker is assumed to be driven by a constant voltage source, v_{c}(t), which has an internal resistance, ft (and an additional resistor may be placed in series to this one). Due to this resistance, the measured voltage, v(t), across the voice coil is reduced by the voltage drop across the internal resistance, ft, (and any additional series resistor) from the applied voltage, vc(t):

v(t)=v_{c}(t)−R_{c}i(Fₑₓ,t)

The contribution of the exogenous force to the voice-coil voltage, v(t), is typically considerably lower than the applied voltage, v_{c}(t). To detect the effects of the exogenous force, therefore, it is preferable to filter the input signal of the loudspeaker in such a way that it contains as little signal energy as possible in the frequency bands where the exogenous effects will be measured. When the exogenous force comprises a sharp transient, this can be detected anywhere in the spectrum, because sharp transients are broad-band. An exogeneous force of this type can therefore be detected at very low frequencies. An advantage of detecting the exogenous force at low frequencies is that sound reproduction is not critical in this band, because human hearing is less sensitive to noise at low frequencies (for example, below a threshold of about 20 Hz). This means that distortion of the applied voltage, v_{c}(t), in the low-frequency band (which may be caused by measuring the effect of the exogenous force) will be less perceptible to a human listener.

An embodiment of the invention is illustrated in FIG. 2. This circuit comprises an input 15 for receiving a first electrical signal from a signal source. It also comprises a loudspeaker terminal, directly or indirectly connected to the input 15, for connection to a loudspeaker 30 for generating the first acoustic signal in response to the first electrical signal and for generating a second electrical signal in response to the second acoustic signal. Here, the first electrical signal provides the applied voltage v_{c}(t); and the second acoustic signal is the signal which exerts the exogenous force on the voice coil. This second acoustic signal generates the second electrical signal to be sensed. As shown in FIG. 2, the loudspeaker terminal is at the voltage, v(t), of the voice-coil of the loudspeaker 30. The circuit has an output 35 for outputting the second electrical signal. The loudspeaker terminal is connected to this output 35 via isolation means 25, which are adapted to suppress or attenuate a signal component related to the first electrical signal while simultaneously passing the second electrical signal to the output 35.

In the example of FIG. 2, the isolation means comprises a low-pass filter 25, for suppressing a high-frequency signal component originating from the first electrical signal. This prevents high-frequency components of the (first) electrical driving signal that is input to the loudspeaker from appearing at the output. The circuit further comprises a high-pass filter 20 connected between the input and the loudspeaker terminal, for suppressing a low-frequency component of the first electrical signal. The low-pass filter 25 has a first cut-off frequency f₁ and the high-pass filter 20 has a second cut-off frequency f₂, which is greater than or equal to the first. This means that the low-pass filter and high-pass filter have pass-bands that do not overlap. The low-pass filter 25 filters the voltage, v(t), across the loudspeaker voice-coil, to ensure that components of the applied input signal do not appear at the output 35. Meanwhile, the high-pass filter filters the input signal to yield v,(t), ensuring that low-frequency components of the input signal are attenuated, so that they do not interfere with the detection of the second signal (due to the exogenous force) in the low-pass band. In this sense, the filters complement one another. The second acoustic signal to be sensed by this circuit comprises either a low-pass signal or a sharp transient signal, which is wide-band and can still be detected in the low-pass band.

There is a voltage drop across the internal resistance, R_{c}, which is represented in a simplified manner in FIG. 2 by the block labelled R_{c}. The voltage across the voice coil, v(t), which contains influences of both v_{c}(t) and the exogenous force, Fₑₓ, is filtered such that the relevant frequency region is retained. In this way, the effects of the exogenous force can be isolated, at least in the relevant frequency region. The resulting signal, vₑₓ(t) at the output 35 can be used for extracting desired properties of the exogenous force.

A first example application of the embodiment of FIG. 2 will now be described, with reference to FIG. 3. In this block diagram, the filtering circuit 40 is the circuit of FIG. 2. The input 15 is connected to a music player 45. Here, the second acoustic signal to be sensed is generated by the footsteps of a user carrying the loudspeaker—for example, while jogging or running. The output 35 is therefore coupled to a pedometer 50 for detecting and counting the footsteps. The individual steps during jogging cause sharp amplitude peaks in the voice-coil signal. These are detectable in the low-pass filtered output signal 35.

A pedometer 50 measures the number of steps taken by a walker or jogger. Pedometers may be used in sports training applications with accompanying software to measure the tempo of the runner and/or the distance covered, or to adjust the tempo of the music produced by the music player 45, to match that of the runner. A conventional pedometer usually includes (electro-) mechanical sensors (such as vibration sensors) to detect the individual steps. However, according to the present embodiment of the invention, this vibration sensor is provided by the loudspeaker 30.

A second example application of the embodiment of FIG. 2 will now be described, with reference to FIG. 4. This example is similar to that of FIG. 3, but the pedometer 50 is replaced by a controller 60. Here, the second acoustic signal (produced by the exogenous force) is generated by a user tapping the loudspeaker 30. The output 35 of the filtering circuit 40 is connected to a controller 60, which is adapted to control the music player device 45 in response to the tapping. To facilitate user control of the audio device 45, finger tapping can be used for basic control (such as volume up or down in a music player; skipping to the next track; or rewinding to the previous track).

In either application, the sharp transients caused by jogging or tapping the device, respectively, can be detected at the filtered output 35 by suitable signal analysis means. For example, the amplitude of the filtered output may be monitored to detect a peak amplitude or a peak difference which is greater than a preset threshold.

In applications like the two described, the loudspeaker will typically be a headphone. When the exogenous force is used as a control input (as in the example of FIG. 4, more complex control will be possible if the loudspeaker comprises stereo headphones. In this case, the circuit of FIG. 2 may be replicated for each stereo channel. The tapping can then be detected independently on the left and right channels, so that tapping either headphone individually causes the controller 60 to execute a different command. For example, the left headphone could be tapped to reduce the playback volume and the right headphone tapped to increase the volume. The number of taps could also be used to discriminate between commands: for example, a double-tap could indicate “skip to next track”.

The embodiments of FIGS. 3 and 4 can also be combined. In this case, the sharp transients due to footsteps will appear in both the left and right stereo channels, whereas the tapping by the user to control the music player 45 will only be detected on a single channel at any given time (assuming the user taps only one headphone at a time). Therefore, the tapping may be distinguished from the footsteps by, for example, studying a difference between the left headphone signal and the right headphone signal.

The invention provides simultaneous reproduction and registration of sound signals. This turns the loudspeaker into a sensor that can be used as an input device while outputting sound at the same time. This is achieved without requiring a separate microphone.

It is important to note that conventional loudspeakers can be used with embodiments of the invention. For the headset applications, traditional headsets, with traditional connectors can be used. New functionalities can be incorporated in a music player (for example) without the need for a special type of headset or connectors.

In general, the proposed invention allows to register certain classes of signals without the need of a microphone or vibration sensor, using only a loudspeaker that may be simultaneously used for continuous sound reproduction.

In embodiments relying on band-pass filtering to isolate the signals, the only limitation is that the registered signals should be band-limited (or can be made band-limited while retaining the relevant information). Preferably the signals to be registered should be non-overlapping with the signal that is being reproduced by the loudspeaker.

While the invention has been illustrated and described in detail in the drawings and foregoing description, such illustration and description are to be considered illustrative or exemplary and not restrictive; the invention is not limited to the disclosed embodiments.

Methods according to embodiments of the invention can be implemented in software for a programmable microprocessor or microcontroller. In this case, some or all of the electrical signals described above may be replaced by digital data. This may facilitate easy manipulation and processing—for example, to numerically analyse the second signal generated in response to the exogenous force.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. An apparatus for generating a first acoustic signal and simultaneously sensing a second acoustic signal, wherein the second acoustic signal comprises a frequency component in a band that does not overlap with the first acoustic signal, the apparatus comprising:
an input for receiving a first electrical signal from a signal source;
a loudspeaker terminal, directly or indirectly connected to the input, for connection to a loudspeaker for generating the first acoustic signal in response to the first electrical signal and for generating a second electrical signal in response to the second acoustic signal; and
an output, for outputting the second electrical signal,
wherein the loudspeaker terminal is connected to the output via isolation means comprising a first filter which is adapted to suppress a frequency component related to the first electrical signal while simultaneously passing the second electrical signal to the output.

2. The apparatus of claim 1, wherein the first filter has a first pass-band,
the apparatus further comprising a second filter connected between the input and the loudspeaker terminal, for suppressing a frequency component of the first electrical signal corresponding to the pass-band of the first filter.

3. The apparatus of claim 2, wherein the first filter comprises a low-pass filter, for suppressing a high-frequency signal component of the first electrical signal.

4. The apparatus of claim 3, wherein the second filter comprises a high-pass filter, for suppressing a low-frequency component of the first electrical signal.

5. The apparatus of claim 4, wherein the low-pass filter has a first cut-off frequency (f₁) and the high-pass filter has a second cut-off frequency (f₂), wherein the first cut-off frequency is less than or equal to the second.

6. (canceled)

7. The apparatus of claim 5, wherein:
the second acoustic signal comprises a sharp transient signal generated by footsteps of a user carrying the loudspeaker; and
the output is coupled to a pedometer for detecting the footsteps.

8. The apparatus of claim 5, wherein:
the signal source is a personal electronic device;
the second acoustic signal comprises a sharp transient signal generated by a user tapping the loudspeaker; and
the output is connected to a controller adapted to control the device in response to the tapping.

9. A personal audio device, comprising:
a loudspeaker; and
the apparatus claim 1.

10. A method of generating a first acoustic signal and simultaneously sensing a second acoustic signal, wherein the second acoustic signal comprises a frequency component in a band that does not overlap with the first acoustic signal, the method comprising:
driving a loudspeaker with a first electrical signal to generate the first acoustic signal, wherein the loudspeaker simultaneously generates a second electrical signal in response to the second acoustic signal; and
sensing the second electrical signal generated by the loudspeaker,
wherein the step of sensing the second electrical signal comprises:
receiving a combined electrical signal from the loudspeaker, the combined electrical signal comprising the first electrical signal and the second electrical signal; and
filtering the combined electrical signal to suppress the first electrical signal.

11. The method of claim 10, further comprising filtering the first electrical signal before it is used to drive the loudspeaker,
wherein the filtering applied to the first electrical signal is complementary to the filtering applied to the combined electrical signal.

12. (canceled)

13. (canceled)

14. The method of claim 9, wherein the second acoustic signal to be sensed comprises a sharp transient signal.
